(19) United States
(12) Patent Application Publication
(10) Pub. No.: US 2021/0316958 A1
(43) Pub. Date: Oct. 14, 2021

(54) ADJUSTABLE EXPANSION SPOOL ASSEMBLY

(71) Applicant: Todd Anthony Travis, Humble, TX (US)

(72) Inventor: Todd Anthony Travis, Humble, TX (US)

(21) Appl. No.: 16/844,325

(22) Filed: Apr. 9, 2020

(51) Int. Cl. B65H 75/24

(52) U.S. Cl. CPC B65H 75/241

(57) ABSTRACT

An assembly for an adjustable expansion spool that accommodates various lengths of pipe and can be adjusted in the field to a customized length to connect two pipes. One embodiment of the adjustable expansion spool has a main body that has one end inserted into a first connection box and a second end inserted into a second connection box. Both the first connection box and the second connection box can be capable of being coupled to a first flange and a second flange respectively. Both flanges encircle the main body and have an annular groove. Housed between the flanges and a ring groove on the main body is a ring. By adjusting the length between the second flange and a peripheral flange on the second connection box, the adjustable expansion spool can be expanded or contracted, depending on the needs of the user on site in the field.

### BACKGROUND

### Technical Field

The present disclosure relates to an expansion spool assembly. More particularly, and not by way of limitation, the present disclosure is directed to a system and method for an adjustable expansion spool, the length of which can be changed on-site without requiring further fabrication. One embodiment can be used for connecting pipes in the oil and gas industry as well as other plumbing or industrial applications.

### Background

This background section is intended to provide a discussion of related aspects of the art that could be helpful to understanding the embodiments discussed in this disclosure. It is not intended that anything contained herein be an admission of what is or is not prior art, and accordingly, this section should be considered in that light.

Expansion spools are commonly used in the oil and gas industry to connect two pipes together. They can be used to mitigate and prevent the effect of expansion and contraction induced by changes in the temperature of the pipes. The expansion spools can be disconnected from the pipes for maintenance and replacement.

An expansion spool can be prefabricated in specified lengths. Typically, a user must fabricate an expansion spool of a length corresponding to the distance between the two pieces of pipe to be connected and transport the bulky expansion spool to the construction site. If an expansion spool with an incorrect length is chosen and transported, the construction will not be able to proceed until an expansion spool of proper length is procured. The unsuitable expansion spool must be disposed of and one of correct length transported, causing additional work and prolonging the construction period. Many of the existing expansion spools can only carry low-pressure fluids and are not suitable for high-pressure fluids such as drilling mud, fracturing fluids, and oil and gas produced incidental to drilling activities.

One method for addressing the sizing issue discussed above is to thread the external surface of the expansion spool to allow the length to be adjusted. In other words, the expansion spool can be fabricated so that a segment of the external surface is threaded. If the length of the expansion spool needs to be adjusted, then the excess length of the expansion spool can be cut. This requires that the expansion spool be pre-threaded prior to using it in the field, which means more time and preparation, as well as man power, are needed to prep for going to the field, regardless of whether the extra threads on the adjustable spool are used.

The amount of adjustment in the expansion spool available to a crew in the field is dependent on how much of the external surface is threaded. For example, if the crew brings a ten-foot expansion spool having three feet of threads on the exterior surface when a six-foot spool is needed, the crew will be unable to utilize the ten-foot spool. If the ten-foot spool is cut to a six-foot length, then the three feet of threads will also be removed, preventing the connection from being made.

The present disclosure aims to solve these problems by using an adjustable expansion spool. As disclosed herein, the adjustable expansion spool has a much wider range of adjustment and does not require threads on the external segment.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

The present disclosure provides multiple advantages over existing expansion spools. The length of the adjustable spool can be adjusted on-site so that selection of the correct length prior to arriving at the construction site is not critical. In one embodiment, the adjustable length is provided by utilizing a main pipe having a first end inserted into a first connection box and a second end inserted into a second connection box. A second connection flange encircles the rim of the entrance aperture to the second connection box. Bolts are inserted through a set of holes on the second connection flange and into a coaxial set of holes in a second flange that encircles a body groove on the outside circumference of the main body.

Housed between the body groove and a matching groove in the flange is a segmented ring. The segmented ring can have a cross-section hexagon shape to mate with the body groove and the matching groove in the flange to couple the main body to the second connection box. The length of the expansion spool can be adjusted by changing the length of the distance between the second flange and the second connection flange. In one embodiment, the shear stress applied to the wall of the expansion spool is eliminated, and thus allowing the spool to safely carry high-pressure fluids.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is an exploded cross-section assembly view of an embodiment of an adjustable expansion spool.

FIG. 2 is a partial cross-section view of the first receiving compartment in the first connection box of an embodiment of an adjustable expansion spool.

FIG. 3 is a partial cross-section side view of the first end of the main body of an embodiment of an adjustable expansion spool.

FIG. 4 is an end view of the first end of the first main body of an embodiment of an adjustable expansion spool.

FIG. 5 is a cross-section top view of the first end of the first main body of the adjustable expansion spool of FIG. 4.

FIG. 6 is an end view of a segmented ring of an embodiment of an adjustable expansion spool.

FIG. 7 is a cross-section side view of an embodiment of a half of a two-piece segmented ring of the adjustable expansion spool of FIG. 6.

FIG. 8 is an enlarged partial cross-section view of one end of the segmented ring of FIG. 7.

FIG. 9 is an end view of the second connection box of one embodiment of an adjustable expansion spool.

FIG. 10 is a cross-section top view of the second connection box of the adjustable expansion spool of FIG. 9.

FIG. 11 is a cross-section top assembly view of an embodiment of an adjustable expansion spool in an un-shortened state.

FIG. 12 is a cross-section top assembly view of an embodiment of an adjustable expansion spool in a shortened state.

FIG. 13 is a cross-section top assembly view of an alternate embodiment of an adjustable expansion spool.

FIG. 14 is a cross-section top assembly view of an alternate embodiment of an adjustable expansion spool.

FIG. 15 is a cross-section assembly view showing a segmented ring housed between two different grooves in an embodiment of the adjustable expansion spool.

### DETAILED DESCRIPTION

All illustrations of the drawings are for the purpose of describing selected versions of one embodiment and are not intended to limit the scope. Embodiments can be constructed of a wide variety of materials that are known to one of ordinary skill in the art. However, it is preferred that an embodiment be constructed of a material that is strong, durable, tough, weather-resistant, and/or easily manufacturable.

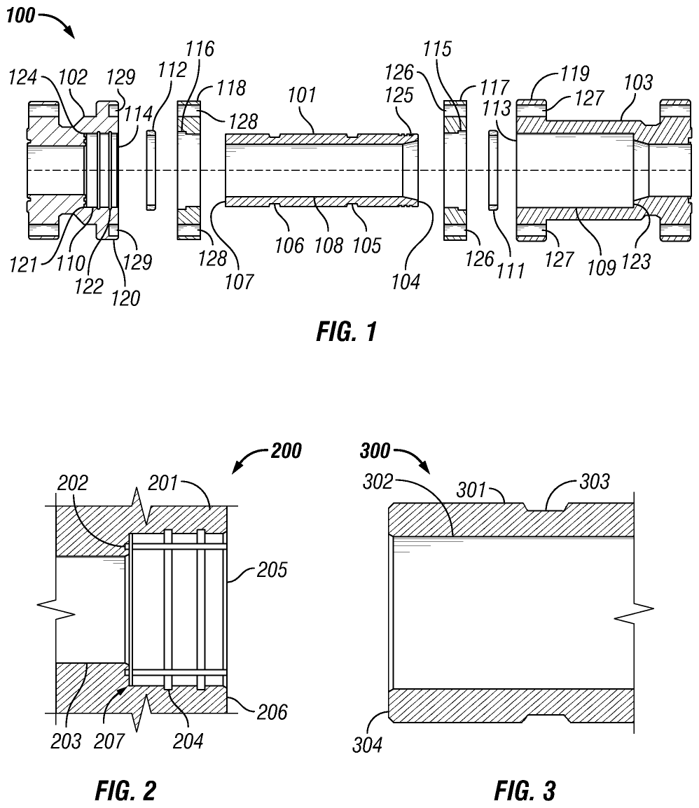

FIG. 1 is an exploded cross-section assembly view of an embodiment of an adjustable expansion spool. The adjustable expansion spool assembly 100 allows for the length of the spool to be adjusted so that when one embodiment is utilized in the field, the adjustable expansion spool assembly 100 need not be prefabricated to an exact length. This allows the crew that is utilizing the adjustable expansion spool to make adjustments as needed on location.

In one embodiment, the adjustable expansion spool assembly 100 is comprised of three components, a first connection box 102, a second connection box 103, and a main body 101. The main body 101, has a main fluid chamber 108 that traverses the length of the main body 101 from the first main end 107 to the second main end 104. Along the outer surface of the main body 101, there can be one or more grooves 105, 106 that traverse the circumference of the main body 101. Each of the grooves 105, 106 is shaped to effectively house an inner portion of one of the segmented rings 111, 112. Both rings can have a hexagonal cross-section shape. The rings 111, 112 can each comprise two or more segments depending on the circumstances and needs of the particular application. While the hexagonal cross section is presented in the displayed embodiment, it is not required. Other cross-section shapes such as a rectangle, an octagon, a circular shape or any other shape could be used as well. The advantage of the use of the hexagonal shape disclosed herein is discussed in further detail below.

The second connection box 103 mates with the second main end 104 by insertion of the second main end 104 into the second aperture 113 of the second connection box 103. The second aperture 113 opens into the second fluid chamber 109 of the second connection box 103. The second fluid chamber 109 can have an inner diameter that is slightly larger than the outer diameter of the second main end 104. This allows for the second main end 104 to pass through the second fluid chamber 109 until it reaches the second stop pocket 123. The second stop pocket 123 has a shoulder that protrudes inward from the inner surface of the second fluid chamber 109. As a result, the second fluid chamber 109 becomes narrower at the second stop pocket 123, providing a positive stop for second main end 104. When second main end 104 is inserted into the second connection box 103, the main fluid chamber 108 is aligned with the second fluid chamber 109 of the second connection box 103.

At the other end of the main body 101, the first main end 107 is inserted into the first aperture 114 on the first connection box 102. A first stop pocket 124 provides a positive stop, preventing the first main end 107 further insertion into the first connection box 102. The first stop pocket 124 has a bottom seal groove 121 that houses an o-ring (not shown) secure the main body 101 to the first connection box 102. A first fluid channel 110 can have annular sealing grooves 122 which can be used to house additional seals. The displayed embodiment has two annular seal grooves 122, but any sealing configuration could be used. Once the first connection box 102 has been slipped over the first main end 107, the first fluid channel 110 is now in line with the main fluid channel 108 which is in line with the second fluid channel 109.

Along the rim of the second aperture 113 is a second connector flange 119 on the second connection box 103. Arranged in a circular pattern around the second connector flange is a set of second connection holes 127. These holes can be aligned with a corresponding set of second holes 126 arranged in a circular pattern around the second flange 117. The second flange 117 houses the outer portion of second segmented ring 111 in a second flange groove 115 has and can have a shape to match the shape of the second segmented ring 111. An isosceles trapezoidal shape allows for the side walls of the second flange groove 115 to abut against a hexagon shaped second segmented ring 111. As a result, the second segmented ring 111, when housed in the second flange groove 115, is placed in compression rather than shear as would be the cause with a rectangular cross-sectional shape. By eliminating the shear force, the segmented rings can withstand a relatively greater operating pressure than a comparably sized rectangular ring.

When the second segmented ring 111 is housed in the second flange 117, the second flange 117 can be coupled to the main body 101 by any known means. For example, the second flange 117 can be bolted to the main body. Once the second connection flange 117 is in position, fasteners can be inserted into the set of second connection holes 127 that are located on the second connection flange 119 so that they pass therethrough into corresponding holes on the second flange 117. In one embodiment, the fasteners can be bolts that pass through the holes in the second connection flange 119 and then through the holes in the second flange 117. The second flange 117 can have a set of nuts that are threaded on to the bolts. Likewise, the second connection flange 119 can have a set of nuts that are threaded onto the portion of the bolts that protrude out on both sides of the second connection flange 119. The nuts and bolts can be varied in length to change the length of the spool as needed. A plurality of o-ring trenches 125 traverse the circumference of the outside surface of the main body 101 and can each house an o-ring (not shown) for sealing the connection between the second main end 104 and the second connection box 103.

On the first main end 107, the first segmented ring 112 is housed in a first flange groove 116. The first flange 118 has a set of first holes 128 to match a set of first connection holes 129 on the first connection flange 120 that are located along the rim of the first aperture 114. Fasteners such as bolts or studs can be used to secure the first connection flange 120 to the first flange 118. In one embodiment, the bolts pass through the holes in the first flange 118 and are screwed into threaded holes of the first connection flange 120. The embodiment in FIG. 1 displays the set of first connection holes 129 in the first connection flange 120 as blind holes—i.e., holes that do not allow for complete passage through the first connection flange 120. However, holes that are not blind can be utilized as well.

Once the adjustable expansion spool assembly 100 is assembled, it can be inserted between two pipes such as those commonly utilized in oil field operations—e.g., in a hydraulic fracturing pipe system. The outside end of the first connection box and the outside end of the second connection box are displayed in FIG. 1 have flanges with holes that allow for coupling to a corresponding flange. However, any method known by one of ordinary skill in the art of coupling pipe together with a spool could be used.

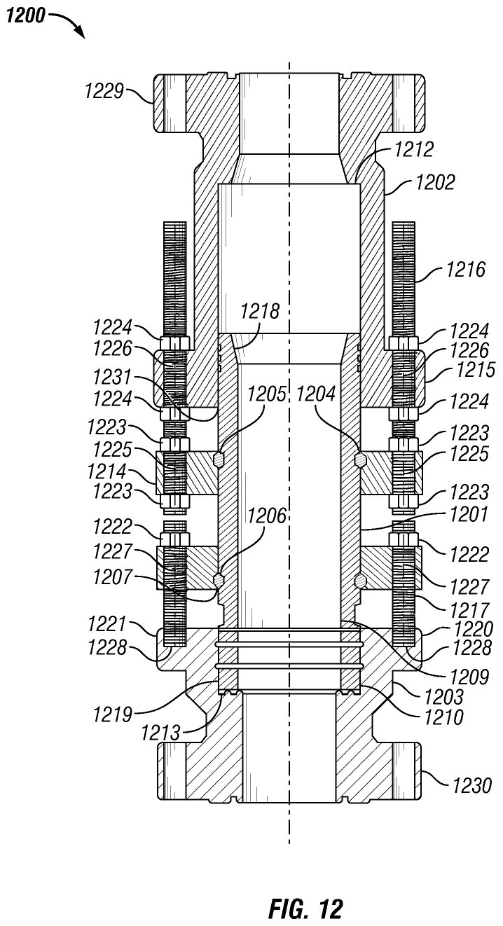

The adjustable expansion spool assembly 100 is adjustable in length. The adjustment is made by adjusting the length of the fastener connecting the second flange 117 and the second connector flange 119. This length between the second flange and the second connector flange is adjusted by relocating where the set of nuts that are threaded on to the bolts that traverse through the sets of holes on both flanges are located. Turning and repositioning one or both sets of nuts can adjust the length between the two flanges. Further discussion of how the relative position of the second flange 117 and the second connector flange 119 can be varied is discussed below with reference to FIG. 12.

By adjusting the aforementioned length, the second main end 104 is repositioned along the second fluid channel 109. The seal is maintained by o-rings located in the sealing grooves 125. In one embodiment, the second fluid channel 109 has a length of 36 inches from the second stop pocket to the end of the second connection box 103. This allows for approximately 30 inches of adjustment while keeping the o-ring seals engaged with the second fluid channel 109.

FIG. 2 is a partial cross-section view of the first receiving compartment in the first connection box of an embodiment of an adjustable expansion spool. The first connection box 201 has a first aperture 205 that can accept the insertion of an end of a main body (not shown). Once the inserted end of the main body passes through the first aperture 205, it can be further pushed through the first fluid channel 203 until reaching the first stop pocket 207. Along the rim of the first aperture 205 is a first connector flange 206. Only the portion of the first connector flange 206 that is adjacent to the first aperture 205 is displayed in FIG. 2, the rest of the first connector flange, including the portion that contains the connector holes, is not shown in in FIG. 2.

Inside the first fluid channel 203 is the first stop pocket 207. This first stop pocket 207 has a shoulder that protrudes inward into the first fluid channel 203 and narrows the inner diameter of the channel. The purpose of the first stop pocket 207 is to provide a stop for an end of the main body in the first connection box 201. On the shoulder of the first stop pocket 207 is a bottom seal groove 202. An o-ring can be housed in the bottom seal groove 202 to first connection box 201 and a main body. One or more annular grooves 204 can traverse the circumference of the first fluid channel 203 for housing o-rings to create a seal.

FIG. 3 is a partial cross-section side view of the first end of the main body of an embodiment of an adjustable expansion spool. As discussed previously, the main body 301 can be tubular, with a main fluid channel 302 running the length of the main body 301. A main body has two ends; however, only the first main end 304 is displayed in FIG. 3. When the first main end is inserted into a first connection box, the main fluid channel 302 can be positioned so that it is in line with a corresponding first fluid chamber in the first connection box. Fluid that enters the main fluid channel 302 can pass into the connected first fluid channel.

The main body 301 can also has a plurality of grooves—e.g., first groove 303. The grooves are located along the outer surface the main body 301 and the grooves traverse the entire circumference of the main body 301. In one embodiment, even if there are more than two grooves, only two will be utilized to house a segmented ring near each end of the main body 301. In FIG. 3, only the first groove 303 is displayed. The first groove in the displayed embodiment has a rectangular shape; however, in one embodiment, the first groove 303 has an isosceles trapezoidal shape to match the hexagon shape of a segmented ring. This, in turn, allows for the ring to be placed under compression instead of shear, increasing the amount of pressure the ring can endure with a given size. An embodiment of the grooves and the segmented ring is discussed in more detail below. Embodiments are not limited to either of the aforementioned shapes for the grooves on the main body 301, and one of ordinary skill in the art can use any known shape to fit a particular application.

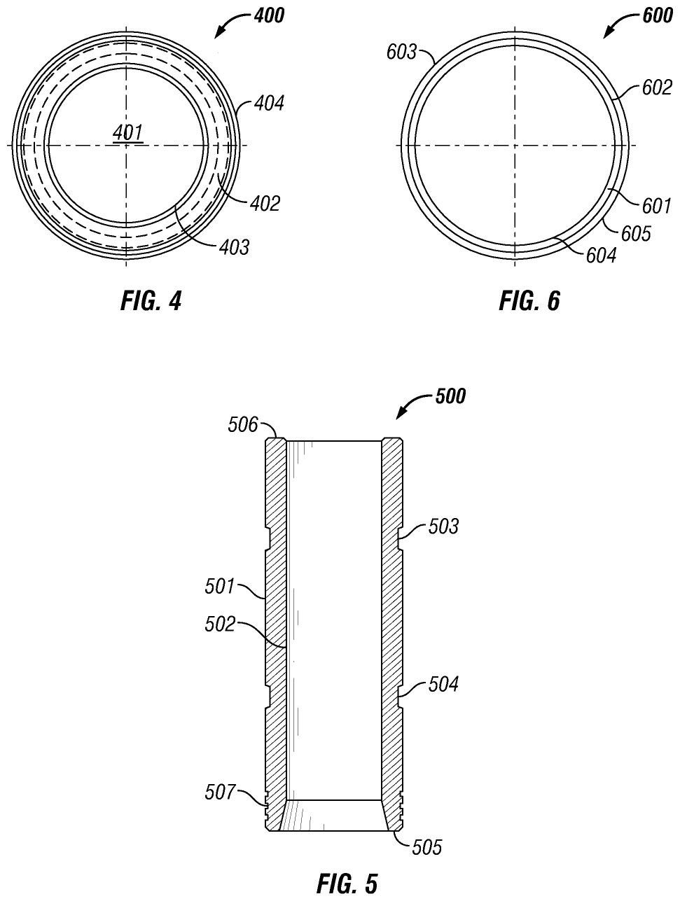

FIG. 4 is an end view of the first end of the first main body of an embodiment of an adjustable expansion spool. The main body 402 can be a tubular shape, with a main fluid chamber 403 around a center aperture 401 that allows passage through the main body 402. The end of the main body 402 shown in FIG. 4 can be inserted into a first aperture of a first connection box. Accordingly, the inner diameter of the first aperture can be slightly larger than the outer diameter of the outer main surface 404. This allows for the main body 402 to be inserted into the first fluid chamber of the first connection box until the main body 402 presses against a first stop pocket in the first connection box and the first fluid chamber of the first connection box to be in-line with the center aperture 401 of the main fluid chamber 403. O-rings in grooves can be used to create a seal to between the main body 402 and the first connection box that has been slipped over the first main end.

FIG. 5 is a cross-section top view of the first end of the first main body of the adjustable expansion spool of FIG. 4. The main body 501 has two ends, a first main end 506 and a second main end 505. The first main end 506 is configured for insertion into a first connection box, and the second main end 505 is configured for insertion into a second connection box. The main body 501 has o-ring trenches 507 that can be located in close proximity to the second main end, and each trench can house an o-ring for creating a seal with the second connection box.

A first groove 503 and a second groove 504 are located on the outer surface of the main body 501. Both grooves can have an isosceles trapezoidal shape for housing the lower portions of segmented rings (not shown) and the upper portions of the segmented rings can be housed in grooves located in respective connection flanges (not shown). The first groove 503 and the second groove 504 can thus be utilized to couple the main body 501 to a first connection box on a first main end 506 and a second connection box on a second main end 505. Once the first main end 506 has been inserted into the first connection box and the second main end 505 has been inserted into the second connection box, a main fluid channel 502 allows for fluid to enter one connection box and pass through the main fluid channel 502 out the other connection box.

FIG. 6 is an end view of a segmented ring of an embodiment of an adjustable expansion spool. In one embodiment, a segmented ring body 601 has two halves, a first half 602 and a second half 603. Both halves can be symmetrical to each other, and both are displayed as having a hexagon shape cross-section. As described above, the hexagon shape allows for the sides of the segmented ring body 601 to abut against the sides of the housing grooves in both a main body and flanges placing the segmented ring body 601 in compression as opposed to shear. Thus, the segmented ring assembly 600 can maintain a connection without failing at a much higher pressure than a rectangular ring of comparable size. A hexagon shape is not required, however, and any shape known by one of ordinary skill in the art could be used.

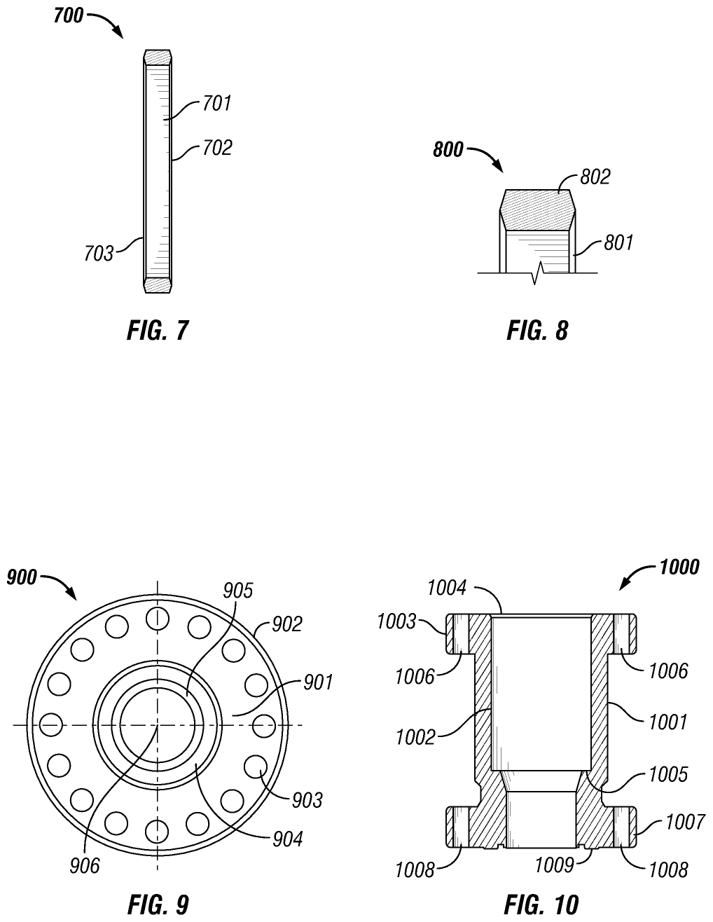

FIG. 7 is a cross-section side view of an embodiment of a segmented ring of the adjustable expansion spool of FIG. 6. The segmented ring body 701 illustrated shows one half of a segmented ring. Both halves can be symmetrical to each other to form a complete ring when combined together. By using a two piece ring, the segmented ring can be placed, for example, in the groove 503 of FIG. 5 prior to assembly of the main body 501 with the connection box. The ring could be comprised of more than two pieces, however, if desired. As in FIG. 6, the segmented ring body 701 in FIG. 7 has a hexagon cross-section shape that allows it to mate with the respective grooves in the connection box and the main body 501.

FIG. 8 is an enlarged partial cross-section view of one end of the segmented ring of FIG. 7. The segmented ring body 801 has a hexagon shape cross-section so as to put the ring in compression instead of shear when the segmented ring body 801 is housed in two adjacent grooves. The segmented ring end 802 is configured so that it can sit adjacent with another end of another half of a segmented ring. When paired, both halves form a complete ring.

FIG. 9 is an end view of the second connection box of one embodiment of an adjustable expansion spool. The second connection box body 901 has a second aperture 906 with an inner diameter larger than the outer diameter of a main body (not shown), such that the main body can be inserted through the second aperture 906 in the second fluid channel 904 of the second connection box body 901. Once inserted, the main body can be pushed through the second fluid channel 904 until it reaches a second stop pocket 905. The second stop pocket 905 has a shoulder providing a positive stop for the main body.

Around the rim of the second aperture 906 is the second connection flange 902. Located around the second connection flange 902 is a set of connection holes 903. The set of connection holes 903 can be arranged in a circular pattern. Each hole is configured to allow for a fastener such as a bolt or stud (not shown) to be inserted through the hole 903 and to a corresponding second flange (not shown). The bolts or studs can have a set of connection nuts (not shown) located on both sides of the second connection flange 902. This allows the nuts to be relocated such that the position of the connection flange can be adjusted relative to a main body.

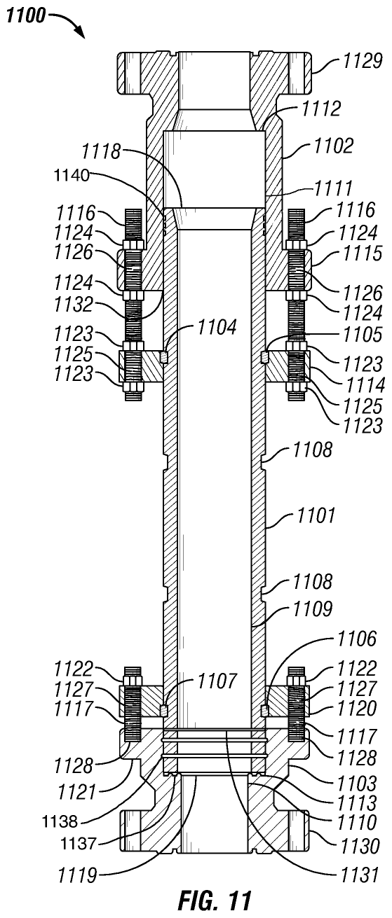

FIG. 10 is a cross-section top view of the second connection box of the adjustable expansion spool of FIG. 9. A second fluid chamber 1002 is housed inside the second connection box 1001 and can be accessed by way of the second aperture 1004. The second fluid chamber 1002 allows for the insertion of a main body end (not shown). Accordingly, the outer diameter of the main body end is smaller than the inner diameter of the second aperture 1004 and the second fluid chamber 1002. This allows for the main end to continue to progress through the interior of the second fluid chamber 1002 unhindered until it hits the second stop pocket 1005. The second stop pocket 1005 has a shoulder that protrudes into the second fluid chamber 1002, narrowing the inner diameter of the second fluid chamber 1002.

Around the rim of and parallel with the second aperture 1004 is the second connection flange 1003. A set of second connection holes 1006 can be located around the second connection flange 1003. This set of second connection holes 1006 is designed so that each hole correlates with another hole on a second flange (not shown) so that fasteners such as studs or bolts may be used to couple the second connection flange 1003 to the second flange. In turn, the main body, which is coupled to the second flange via a segmented ring, is coupled to the second connection flange 1003. On the opposite end from the second aperture 1004, is the pipe connection end 1009. The pipe connection end 1009 has a pipe connection flange 1007 having pipe connection holes 1008 that can correspond with holes on a connector pipe flange (not shown) to secure the second connection box system 1000 to a pipe system.

FIG. 11 is a cross-section top assembly view of an embodiment of an adjustable expansion spool in an un-shortened state. The adjustable system 1100 displayed in FIG. 11 has a main body 1101 with a first main end 1119 inserted into a first connection box 1103 through a first aperture 1131, and a second main end 1118 inserted into a second connection box 1102 through a second aperture 1132. Both the first connection box 1103 and the second connection box 1102 have a first fluid channel 1110 and a second fluid channel 1111, respectively. Once the first connection box 1103 and the second connection box 1102 are assembled to house separate ends of the main body 1101, a main fluid channel 1109 that runs the length the main body 1101 is in line with the first fluid channel 1110 and the second fluid channel 1111. The second main pipe end can be inserted through a second aperture 1132 until it reaches a second stop pocket 1112. However, as shown in FIG. 11, the main pipe end need not be fully inserted, but instead could be stopped at an intermediate location depending on the length required for the application. The second stop pocket 1112 has a shoulder that protrudes into the second fluid channel 1111. Around the rim of the second aperture 1132 is the second connection flange 1115.

A set of second connection holes 1126 can be arranged around the circumference of the second connection flange 1115. The set of second connection holes 1126 match with a corresponding set of second holes 1125 that can be arranged around the circumference of a second flange 1114. The second flange 1114 is situated such that it is adjacent to a second groove 1104 on the main body 1101. An adjacent groove in the second flange 1114 and the second groove 1104 house a second segmented ring 1105. The second segmented ring 1105 traverses the circumference of the second groove 1104. When a threaded stud 1116 is inserted through the a second connection hole 1126 of the set of connection holes and into its corresponding second hole 1125 of the set of second holes 1125, the second flange 1114 pulls the groove in the second flange 1114 against the second segmented ring 1105 housed in the second groove 1104 on the main body 1101. The second bolt 1116 is secured to the second connection flange 1115 with a set of second connection nuts 1124, and it is secured to the second flange 1114 with a set of second nuts 1123.

At the first connection box 1103, the first main end 1119 is inhibited from being inserted any further by a first stop pocket 1113. The first stop pocket 1113 has a shoulder that protrudes into the first fluid channel 1110. Around the rim of the first aperture 1131 is a first connection flange 1121. A set of first threaded connection holes 1128 that can be configured around the first connection flange 1121. The first flange 1120 has a set of matching holes 1127 and a first groove 1106. A segmented ring 1107 is housed in the groove 1106 and a groove in the main body 1101. A plurality of threaded bolts or studs 1117 are placed through first set of holes 1127 and into a first set of threaded connection holes 1128. When the bolts or studs 1117 are tightened, the first flange 1120 is pulled toward the first connection box 1103, causing the segmented ring 1107 to retain the main body in the first connection box 1103.

Depending on the length of the main body 1101, a plurality of additional grooves 1108 can be provided. Unlike the first groove 1106 and the second groove 1104, the additional grooves 1108 do not house a segmented ring in this embodiment. However, these grooves can be utilized if the main body is shortened in the field to provide a different length spool. Specifically, the portion of the main body containing either the first groove 1106 or second groove 1104, or both portions, can be cut off to shorten the main body 1101 as needed.

To connect the expansion spool system to a pipe system, the first connection box 1103 has a first pipe flange 1130, and the second connection box 1102 has a second pipe flange 1129. Both flanges are capable of being connected to other pipes by any method known by one of ordinary skill in the art.

If the embodiment of the expansion spool in FIG. 11 needs to be adjusted, then the distance between the second flange 1114 and the second connection flange 1115 is adjusted. This is done by adjusting the set of nuts 1123 and/or nuts 1124 to change the distance. If the stop 1112 is reached by the main body 1101 and the spool is not short enough, the spool can be further shortened by cutting off the second main end 1118 past the second groove 1104 to make a new second main end 1118 and a new second groove 1104. Then, the second segmented ring 1105 is housed between the second flange 1114 and the new second groove 1104.

In an alternate embodiment, the second main end 1118 can be cut past the second groove 1104 to make a new second main end 1118 and a new second groove 1104 near the second main end 1118. The second connection box 1102 is replaced with an alternate first connection box 1103 being fit over the second main end 1119 and has a similar configuration as the first connection box 1103. Then, the first alternate connection box is secured to the second flange 1114 with the second bolts 1116 passing through a set of first alternate connection holes into the set of second holes 1125. Once the second bolt 1116 is through both sets of holes, a set of first alternate connection nuts secures the second studs to the first alternate connection flange, and the set of second nuts 1123 secures the second flange 1114 to the second bolts 1116. In turn, the first flange 1120 and the second flange 1114 pull on the main body 1101.

The first alternate connection box can be utilized in place of the second connection box 1102 to receive the new second main end 1118 after the main body 1101 has been cut because it can be configured to have a base groove 1137 and annular grooves 1138 that can house o-rings for making a seal similar to the first connection box 1103. These grooves are useful because the annular trenches 1140 that housed o-rings and were used to create a seal between the original second main end 1118 and the second connection box 1102 have now been cut off to make the new second main end 1118. By utilizing the first alternate connection box with the new second main end 1118, a seal can be created without the annular trenches 1140 that are no longer present.

FIG. 12 is a cross-section top assembly view of an embodiment of an adjustable expansion spool in a shortened state. The illustrated embodiment in FIG. 12 is similar to the embodiment that appears in FIG. 11 except that the expansion spool system 1200 has been shortened by changing the length of the main body 1101. A first main end 1219 of a main body 1201 is inserted into a first connection box 1203 to a first stop pocket 1213. Likewise, a second main end 1218 of the main body 1201 is inserted into second connection box 1202. Although shown in an intermediate position, the second main end 1218 can be inserted until it reaches a second stop pocket 1212.

Grooves that traverse the circumference of the main body can be located such that the first groove 1206 is close to the first main end 1219 and the second groove 1204 is close to the second main end 1218. Around the second aperture 1231 at the opening of the second main box 1202 is a second connection flange 1215. The second connection flange 1215 has a set of second connection holes 1226 that correspond with a set of second holes 1225 in a second flange 1214. The second flange 1214 itself encircles the main body 1201 adjacent to the second groove 1204 and a second segmented ring 1205 is housed in the second groove 1204 and the second flange 1214. A second set of studs 1216 can be inserted through the set of second connection holes 1226 and into the corresponding second holes 1225. The second bolts 1216 can be threaded so that it can be secured to the second connection flange 1215 and second flange 1214 by a set of second connection nuts 1224 and a set of second nuts 1223, respectively.

On the other side of the main body 1201, a first flange 1220 has a set of first holes 1227 to match a set of first connection holes 1228. As with the second flange 1214, the first flange 1220 is positioned so that it encircles the main body 1201 adjacent to the first groove 1206, and a first segmented ring 1207 is housed between the first groove 1206 and the first flange 1220. A set of first studs 1217 can be installed through the set of first hole 1227 and into the set of first connection holes 1228. Then the set of first bolts 1217 is secured to the first flange 1220 with a set of first nuts 1222.

One difference between the embodiment in FIG. 11 and FIG. 12 is that the main body 1201 in FIG. 12 has been cut so that there are no longer any alternative grooves like there are in FIG. 11. While the second bolts 1216 in both figures are illustrated as having the same length, the second flange 1214 and the second connection flange 1215 are secured to the second bolts 1216 at a different location so that, instead of the expansion spool system 1200 being expanded, the expansion spool system 1200 is contracted to the smaller length.

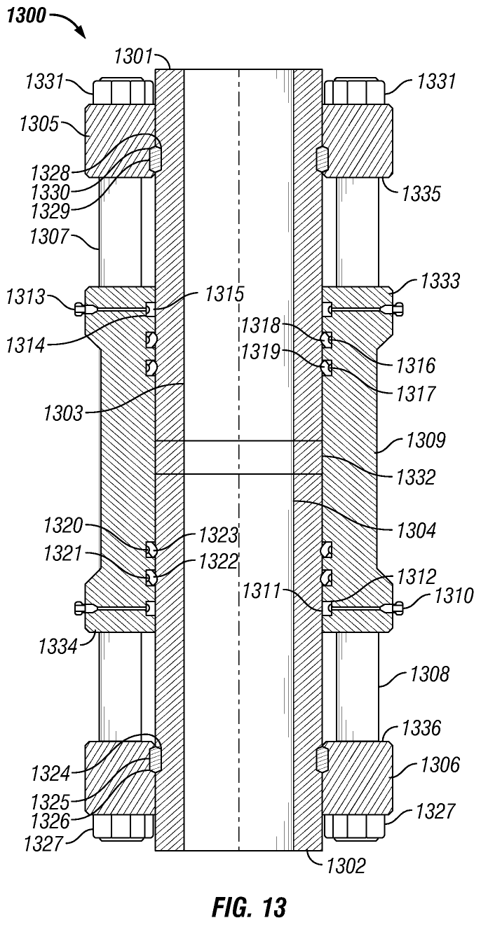

FIG. 13 is a cross-section top assembly view of an alternate embodiment of an adjustable expansion spool. Instead of a single main body, the expansion spool system 1300 has a first main body 1301 and a second main body 1302. A first groove 1328, along with a first flange groove 1329 in a first flange 1305, houses a first segmented ring 1330, with the first groove 1328 traversing the circumference of the first main body 1301 and the first flange groove 1329 encircling the circumference of the first main body 1301. The second main body 1301 has essentially the same feature as the first main body 1302. For instance, a second flange 1306, with a second flange groove 1326, encircles the circumference of the second main body 1302, and a second groove 1324 traverses the circumference of the second main body 1302 with a second segmented ring 1325 housed therebetween.

The first main body 1301 is placed adjacent to the second main body 1302 so that a first fluid channel 1303 is in line with a second fluid channel 1304 and fluid can travel between them. An adapter flange 1309 covers the interface between the first main body 1301 and the second main body 1302. The adapter flange 1309 has six grooves that traverse the circumference of the inner surface on the adapter flange 1309. Not all of the grooves are the same, however. The two grooves on both ends of the adapter flange 1309, first groove 1315 and second groove 1311, are each connected to at least one an injection port, first injection port 1313 and second injection port 1310, respectively. A first seal 1314 is housed in the first groove 1315, and a second seal 1312 is housed in the second groove 1311.

The first seal 1314 and the second seal 1312 can be U-shaped and placed in its corresponding groove so that the open part of the seal is faced toward the injection ports 1310, 1313. Through the injection ports 1310, 1313, a number of different energizing fluids such as plastic packing can be injected to push the first seal 1314 and second seal 1312 out, sealing against the adjacent main bodies 1303, 1304.

The other grooves 1318, 1319, 1323, 1322 can house radial seals that are non-hydraulic energized seals 1316, 1317, 1320, 1321 that seal radially as the main body slides into them. The seals 1314, 1312 in the first groove 1328 and second groove 1311 can be a p-seal, and the seals 1316, 1317, 1320, 1321 in the radial grooves 1318, 1319, 1323, 1322 can be fs-seals.

The adaptor flange 1309 has a set of first bolts 1307 that protrude out of a first connection flange 1333 on the adapter flange 1309 in a direction away from the second main body 1302, parallel to the first main body 1301. These set of first bolts 1307 traverse through a set of first holes 1335 on the first flange 1305 and are secured to the first flange 1305 by a set of first nuts 1331. Similarly, a set of second bolts 1308 protrude out of a second connection flange 1334 on the adapter flange 1309 in a direction away from the first main body 1301, parallel to the second main body 1302. The second bolts 1308 also traverse through a set of second holes 1336 in a second flange 1306 and are secured to the second flange 1306 by a set of second nuts 1327. A spacer ring 1332 which can be used as needed to add more length to obtain the proper length. The spacer ring 1332 is not required and, ideally, would not be needed.

The expansion spool of FIG. 13 can be utilized in a situation in which the user has two adjustable expansion spools, but the required length is too long for either of them to satisfy individually. For example, the user may require an eighteen-foot expansion spool but may only have two ten-foot expansion spools. The solution is to cut one foot off of each expansion spool thereby removing the end flange on each to make two nine-foot expansion spools and combine them end to end with the adapter disclosed above with reference to FIG. 13. By utilizing the embodiment above, a user can take a plurality of expansion spools that are on hand and create an expansion spool system 1300 that satisfies the length requirements even though none of the available expansion spools were initially fabricated to the specified length.

Using this method, an entire operation need not be put on hold while a new expansion spool is fabricated and transported to the field. Often, getting an expansion spool fabricated and to the field can take upwards of three days. The present disclosure allows a crew to take expansion spools on hand and make adjustments in the field as needed. This can reduce the required time to assemble the necessary expansion spool to just one hour, as opposed to three days. The amount of time and money that can be saved by utilizing one embodiment in an oil field scenario cannot be overstated.

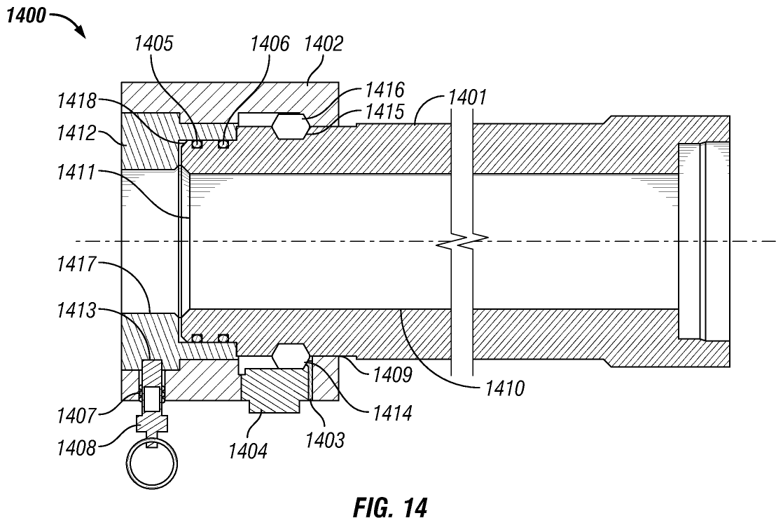

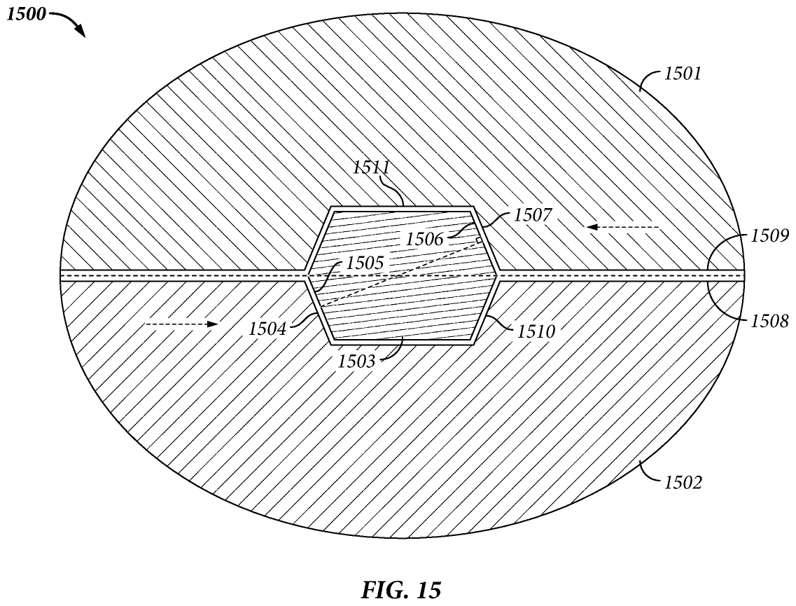

FIG. 14 is a cross-section top assembly view of an alternate embodiment of an adjustable expansion spool. The main body 1401 is inserted into a collar 1402 through a collar aperture 1409. Once inserted, the main end 1411 is adjacent to a connection pipe 1412 such that a connection fluid channel 1417 is in line with a main fluid channel 1410. After the main body 1401 has been inserted into the collar 1402, a retainer plug 1404 that is housed in a retainer hole 1403 is removed. When the retainer plug 1404 is removed, a main groove 1415 and a collar groove 1414 are exposed. The main groove 1415 traverses the outer circumference of the main body 1401; and the collar groove 1414 traverses the inner circumference of the collar 1402.

With the two grooves exposed, a segmented ring 1416 can be inserted through the retainer hole 1403 until the segmented ring 1416 is completely housed between the collar groove 1414 and the main groove 1415. The segmented ring can be comprised of a number of different segments. The length of the segments can be small enough to allow each segment to be inserted one by one through the retainer hole 1403 into the passageway created by the collar groove 1414 and the main groove 1415. After the segmented ring 1416 is housed in the main groove 1415 and the collar groove 1414, the retainer plug 1404 is reinserted into the retaining hole 1403.

When the expansion spool system 1400 is pressurized, pressure is applied the main body 1410 and the connection pipe 1412 in a way that forces them away from each other, causing the main groove 1414 to push against the segmented ring 1416 pressing it against the collar groove 1414. As a result, the segmented ring 1416 stops the main body 1410 from separating from the connection pipe 1412. The segmented ring 1416 is thus under load in operation. In the disclosed embodiment, the hexagon shape of the segmented ring 1416 and the corresponding surfaces of the main groove 1414 and the collar groove 1415 results in the load on the segmented ring 1416 being compression rather than shear.

To assure that the segmented ring 1416 is in compression rather than shear, the bearing surface of the collar groove 1414 can be configured such that a perpendicular line drawn from the center of the bearing surface of the collar groove 1414 across the segmented ring 1416 intersects the opposite bearing surface of the main groove 1415. By designing the segmented ring 1416 and corresponding main groove 1415 in this manner, when pressure is applied, compression force is applied to the ring rather than shear force. Note that the angle of the bearing surfaces will vary with the width of the segmented ring to design the ring in this manner. This results in an increase in the amount of force the ring can withstand, allowing for a smaller ring to be used for a given pressure. Other designs of the segmented ring can be used, however for various applications. For example, in low pressure operations, the loads that the segmented ring must endure could allow square or rectangular retaining rings to be used.

A first o-ring 1405 and a second o-ring 1406 can be housed in o-ring grooves that traverse the outer surface of the main body 1401 near the body/connection interface 1418 to create a seal. The collar 1402 can be secured to the connection pipe 1412 after assembly by the insertion of a locking pin 1408 through a locking pin hole 1407 on the collar 1402. The locking pin 1407 traverses through the collar 1402 to engage in a pocket 1413 on the outer surface of the connection pipe 1412, securing the collar 1402 in the assembled position shown in FIG. 14.

FIG. 15 is a cross-section assembly view showing a segmented ring housed between two different grooves in two components. Such a segmented ring could be used in the various embodiments of an expansion spool. The first component 1501 (the main body, for example) is adjacent with the second component 1502 (the collar, for example), and the segmented ring 1503 is housed between the second component groove 1510 and the first component groove 1511. The second component groove 1510 and the first component groove 1511 have an isosceles trapezoidal shape such that the hexagon cross section of the segmented ring 1503 mates with the grooves.

After the two components 1501, 1502 are fully assembled with the segmented ring 1503, the first component 1501 can be pulled in a direction away from the second component 1502 by operation of the system, for example. In turn, the first component bearing surface 1507 pushes on the first ring bearing surface 1506. Likewise, the second component 1502 pushes the second component bearing surface 1504 against the second ring bearing surface 1505. The first component bearing surface 1507 can be configured so that a perpendicular line drawn from the center of the first component bearing surface 1507 intersects the second component bearing surface 1504. By designing the segmented ring 1503 and the grooves in this manner, when pressure is applied, compression force is applied to the segmented ring 1503 rather than shear force. The segmented ring can be made out of a wide variety of materials depending on the application and strength needed including a stainless metal alloy.

Note that the angled groove surface that is opposite the first component bearing surface 1507 in first component groove 1511 does not have significant pressure applied to it by the ring 1503 during operation of a pressurized fluid system. Likewise, the angled groove surface that is opposite the second component bearing surface 1504 in the second component groove 1510 also does not have significant pressure applied to it by the ring 1503 during operation of a pressurized fluid system. As such, the shape or design of the grooves in these areas do not generally affect the type of load or forces that are applied to the ring 1503 during normal operation. As a result, the angle or shape at these locations of both the groove and the ring is not critical from a design perspective.

For example, as shown in FIG. 14, with the expansion spool fully assembled, the collar groove 1416 only contacts one bearing surface of the segmented ring 1416. The opposite bearing surface of the segmented ring 1416 in the collar groove 1414 is open such that the collar 1402 could slide to the right when the locking pin 1408 is not engaged. Thus, the shape of the ring and/or groove is not a consideration for the non-load bearing portions and in fact could be removed completely as illustrated by FIG. 14.

While this disclosure has been particularly shown and described with reference to preferred embodiments, it will be understood by those skilled in the art that various changes in form and detail may be made therein without departing from the spirit and scope of the invention. The investors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called filed. Further, a description of a technology as background information is not to be construed as an admission that certain technology is prior art to any emboidment9s) in this disclosure. Neither is the “Brief Summary” to be considered as a characterization of the embodiments(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of the such claims shall be considered on their own merits in light of this disclosure but should not be constrained by the headings set forth herein.

We claim:

1. An adjustable expansion spool assembly comprising:
a first connection box, the first connection box having a first receiving compartment, the first connection box having a first peripheral flange, wherein the first peripheral flange is located along the rim of a first inner aperture of the first receiving compartment;
a second connection box, the second connection box having a second receiving compartment, the second connection box having a second peripheral flange, wherein the second peripheral flange is located along the rim of a second inner aperture of the second receiving compartment;
a main body, the main body having a first main end that is located on the opposite side of the main body from a second main end, wherein the first main end is inserted into the first inner aperture of the first connection box, and the second main end is inserted into the second inner aperture of the second connection box;
the main body having a first ring groove and a second ring groove, wherein the first ring groove houses a first ring, and the second ring groove houses a second ring;
a first ring flange coupled to the main body, the first ring flange having a first annular groove, wherein the first annular groove is located adjacent to the first ring groove and houses the first ring;
a second ring flange coupled to the main body, the second ring flange having a second annular groove, wherein the second annular groove is located adjacent to the second ring groove and houses the second ring; and
the first peripheral flange is coupled to the first ring flange, and the second peripheral flange is coupled to the second ring flange allowing for the length of the adjustable expansion spool assembly to be adjusted.

2. The adjustable expansion spool assembly of claim 1 further comprising:
the first peripheral flange having a plurality of first holes, the second peripheral flange having a plurality of second holes, the first ring flange having a plurality of first ring holes, the second ring flange having a plurality of second ring holes, wherein each first hole is configured to be coaxial with a first ring hole, and each second hole is configured to be coaxial with a second ring hole.

3. The adjustable expansion spool assembly of claim 2 further comprising:
the first peripheral flange is coupled to the first ring flange by a plurality of first threaded bolts; and
the second peripheral flange is coupled to the second ring flange by a plurality of second threaded bolts.

4. The adjustable expansion spool assembly of claim 1 further comprising:
the first connection box having a first fluid chamber in-line with the first receiving compartment;
the second connection box having a second fluid chamber in-line with the second receiving compartment; and
the main body having a main fluid chamber, wherein the main fluid chamber is in-line with the first receiving compartment and the second receiving compartment.

5. The adjustable expansion spool assembly of claim 1, wherein the first receiving compartment further comprises a bottom sealing groove located at the interface between the first main end and the first receiving compartment.

6. The adjustable expansion spool assembly of claim 1, wherein the second receiving compartment further comprises a bottom sealing groove located at the interface between the second main end and the second receiving compartment.

7. The adjustable expansion spool assembly of claim 1, wherein the first receiving compartment further comprises a plurality of annular sealing grooves, wherein the annular sealing grooves traverse the entire circumference of a first inner surface of the first receiving compartment and are parallel with the first inner aperture.

8. The adjustable expansion spool assembly of claim 1, wherein the second receiving compartment further comprises a plurality of annular sealing grooves, wherein the annual sealing grooves traverse the entire circumference of a second inner surface of the second receiving compartment and are parallel with the second inner aperture.

9. The adjustable expansion spool assembly of claim 1 further comprising:
the main body having a plurality of o-ring trenches, wherein the plurality of o-ring trenches are located near the second main end of the main body and traverse the entire circumference of an outer main surface; and
each o-ring trench of the plurality of o-ring trenches housing an o-ring of a plurality of o-rings.

10. The adjustable expansion spool assembly of claim 1 further comprising:
a first pipe having a first pipe flange;
the first connection box having a first connector flange, wherein the first connector flange is located on the opposite side of the first connection box from the first peripheral flange, and the first connector flange is capable of being coupled to a first pipe flange;
a second pipe having a second pipe flange; and
the second connection box having a second connector flange, wherein the second connector flange is located on the opposite side of the second connection box from the second peripheral flange, and the second connector flange is capable of being coupled to a second pipe flange.

11. The adjustable expansion spool assembly of claim 10 further comprising:
the first connector flange having a plurality of first connector holes, the second connector flange having a plurality of second connector holes, the first connector flange having a plurality of first outer connector holes, the second connector flange having a plurality of second outer connector holes, the first pipe flange having a plurality of first pipe holes, the second pipe flange have a plurality of second pipe holes, wherein each first connector hole is configured to be coaxial with a first pipe hole, and each second connector hole is configured to be coaxial with a second pipe hole; and

12. The adjustable expansion spool assembly of claim 11 further comprising:
the first connector flange is coupled to the first pipe flange by a plurality of first outer threaded bolts; and
the second connector flange is coupled to the second pipe flange by a plurality of second outer threaded bolts.

13. The adjustable expansion spool assembly of claim 1 further comprising:
the first ring groove having an isosceles trapezoidal shape, the second ring groove having an isosceles trapezoidal, the first annular groove having an isosceles trapezoidal shape, the second annular groove having an isosceles trapezoidal; and
the first ring having a cross-sectional hexagonal shape, the second ring having a cross-sectional hexagonal shape.

14. An adjustable expansion spool assembly comprising:
An adapter flange, a first main body, a second main body, wherein the first main body is inserted through a first aperture on one end of the adapter flange and the second main body is inserted through a second aperture on an opposite end of the adapter flange so that a first fluid chamber housed in the first main body is adjacent to and in line with a second fluid chamber housed in the second main body;
a first ring groove that traverses the entire circumference of the first main body, a first ring, a first flange having a first annular groove, wherein the first ring is housed between in the first ring groove of the main body and the first annular groove of the first flange;
a second ring groove that traverses the entire circumference of the second main body, a second ring, a second flange having a second annular groove, wherein the second ring is housed between in the second ring groove of the main body and second annular groove of the second flange;
a set of first bolts coupled to the adapter flange, wherein each bolt of the set of first bolts traverse through a hole of a set of first holes in the first flange and are secured to the first flange with a set of first nuts; and
a set of second bolts coupled to the adapter flange, wherein each bolt of the set of second bolts traverse through a hole of a set of first holes in the first flange and are secured to the first flange with a set of second nuts.

15. The adjustable expansion spool assembly of claim 14 further comprising:
the adapter flange having a plurality of seal grooves, wherein each seal groove of the plurality of sealing grooves traverses the entire circumference of an inner surface of the adaptor flange;
each seal groove of the plurality housing a seal.

16. The adjustable expansion spool assembly of claim 15 further comprising:
at least one fluid port, the at least one fluid port connecting to a fluid channel, the fluid channel housing an energizing fluid, wherein the fluid channel is connected to a sealing groove and the fluid port is configured to utilize the energizing fluid hydraulic energize the seal housed in the sealing groove.

17. The adjustable expansion spool assembly of claim 15, wherein at least one of the seals housed in the seal grooves is a non-hydraulically energized radial seal.

18. The adjustable expansion spool assembly of claim 14 further comprising:
A spacer housing a spacer fluid chamber, wherein the spacer is housed between the first main body and the second main body so that the spacer fluid chamber is in line with the first fluid chamber and the second fluid chamber.

19. The assembly of claim 14 further comprising:
the first ring groove having an isosceles trapezoidal shape, the second ring groove having an isosceles trapezoidal shape, the first annular groove having an isosceles trapezoidal shape, the second annular groove having an isosceles trapezoidal; and
the first ring having a cross-sectional hexagonal shape, the second ring having a cross-sectional hexagonal shape.

20. An adjustable expansion spool assembly comprising:
a main body, a collar, a connection pipe, wherein a main end of the main body is inserted into the collar through a collar aperture until the main end of the main body is adjacent to the connection pipe at a connection/main interface; and
a main groove, a collar groove, wherein the main groove and the collar groove are configured to house a segmented ring between the main groove and the collar and put the segmented ring in compression.

21. The adjustable expansion spool assembly of claim 20, wherein the segmented ring has a plurality of segments.

22. The adjustable expansion spool assembly of claim 21 further comprising:
a retainer hole housing a retainer plug, wherein the retainer hole is configured to allow the individual segments of the segmented ring to traverse through to be housed between the main groove and the collar groove once the retainer plug has been removed.

23. The adjustable expansion spool assembly of claim 20 further comprising:
a locking pin hole housing a locking pin, wherein the locking pin is configured to traverse through the locking pin hole and house an end in a pocket located along an outer surface of the collar.
